(19) United States
(12) Patent Application Publication
(10) Pub. No.: US 2004/0193818 A1
(43) Pub. Date: Sep. 30, 2004

(54) Memory device, memory access limiting system, and memory access method

(75) Inventors: Katsuhiko Hashimoto, Tokyo (JP); Hiroshi Okubo, Tokyo (JP); Masaki Kiyota, Tokyo (JP); Shunji Mitsuishi, Tokyo (JP); Koichi Masutani, Kawasaki (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignees: FUJITSU LIMITED; FFC Limited

(21) Appl. No.: 10/807,180

(22) Filed: Mar. 24, 2004

(30) Foreign Application Priority Data
Mar. 31, 2003 (JP) 2003-097401

(51) Int. Cl. G06F 12/14

(52) U.S. Cl. 711/164; 711/103

(57) ABSTRACT

An IC card is provided with a nonvolatile data area in which data can be read and written, a nonvolatile key data area into which data can be written but cannot be read, and a nonvolatile key register into which data can be written but cannot be read. Writing predetermined data, which are not encrypted but need to be kept secret, into the data area and key data into the key data area, inhibits reading and writing data in the data area. Reading or writing in the data area is authorized only if proper key data are written into the key register, and inhibited if improper key data are written into the key register.

### CROSS-REFERENCE TO RELATED APPLICATIONS

This application is based upon and claims the benefit of priority from the prior Japanese Patent Application No. 2003-097401, filed on Mar. 31, 2003, the entire contents of which are incorporated herein by reference.

### BACKGROUND OF THE INVENTION

1) Field of the Invention

The present invention relates to a technique for controlling access to data stored in the memory device with a built-in integrated circuit (IC).

2) Description of the Related Art

Tags are attached to air cargo to manage routing of the air cargo to the destination. International Air Transport Association (IATA) marks IATA codes on these tags.

However, recently, memory cards with built-in ICs (IC cards) have come into market. These IC cards are convenient. For example, the IC cards have portability, reading and writing of data can be easy performed at the destination, lot of information such as information about merchants, contents, airports of shipment and destination, and routes can be stored etc. Because of these advantageous, IC cards have replaced the conventional tags. However, because the IC cards contain important data, how to prevent tampering of the data stored in the IC card is a task that needs to be solved.

One approach to prevent the tampering of the data is to encrypt the data and allow access to the data to those that have a valid password. In the technology disclosed in Japanese Patent Application Laid-Open No. H9-204361 (1997), even a person who does not have a valid password is allowed to perform a test to check whether a memory in the IC card is defective.

### SUMMARY OF THE INVENTION

A memory device according to one aspect of the present invention includes a nonvolatile first data area that stores first data that are not encrypted and that can be read and written; a nonvolatile first key data area that stores first key data that can be written but can not be read; a nonvolatile second key data area that stores second key data that can be written but can not be read; and a controller that allows reading or writing of the first data when the first key data matches with the second key data.

A memory access limiting system according to another aspect of the present invention includes a memory device that includes a nonvolatile first data area that stores first data that are not encrypted and that can be read and written; a nonvolatile first key data area that stores first key data that can be written but can not be read; a nonvolatile second key data area that stores second key data that can be written but can not be read; and a controller that allows reading or writing of the first data when the first key data matches with the second key data; a writing unit that writes the first data into the first data area and the first key data into the first key data area; a first interface unit that is used for transmission and reception of data between the writing unit and the memory device; a reading/writing unit that writes the second key data into the second key data area, and accesses the first data area for reading and writing the first data; and a second interface unit that is used for transmission and reception of data between the reading/writing unit and the memory device.

A memory access method according to still another aspect of the present invention includes a first writing that includes writing a predetermined unencrypted data into a nonvolatile first data area from which data can be read and written after resetting the first data area, and writing key data into a nonvolatile second data area into which data can be written but can not be read; inhibiting the reading and the writing of the first data; a second writing that includes writing temporary key data into a nonvolatile key register, into which data can be written but can not be read when the reading and the writing of the first data are inhibited; and authorizing the reading or writing of the first data when the temporary key data match the key data, whereas inhibiting the reading and the writing of the first data when the temporary key data do not match the key data.

The other features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of an IC card according to a first embodiment of the present invention;

FIG. 2 is a schematic of an access limiting system according to the first embodiment;

FIG. 3 is a flowchart of a method of accessing the IC card according to the first embodiment;

FIGS. 4A and 4B are views to explain contents of a memory in the IC card when the access method is executed according to the first embodiment;

FIGS. 5A to 5D are views to explain contents of a memory in the IC card when the access method is executed according to the first embodiment;

FIG. 6 is an example of a transmission/reception of the key data and the IC card according to the first embodiment;

FIG. 7 is another example of a transmission/reception of the key data and the IC card according to the first embodiment;

FIG. 8 is a flowchart of a method of accessing the IC card according to a second embodiment;

FIGS. 9A to 9D are views to explain contents of a memory in the IC card when the access method is executed according to the second embodiment;

FIG. 10 illustrates a memory map of the IC card according to a third embodiment;

FIG. 11 is a flowchart of a method of accessing the IC card according to the third embodiment;

FIG. 12 illustrates a memory map of the IC card according to a fourth embodiment; and

FIG. 13 is a flowchart of a method of accessing the IC card according to the fourth embodiment.

### DETAILED DESCRIPTION

However, when IC cards are used for the air cargo, encryption of data is not preferable due to the following reason. In an airport, air cargo is placed on a belt conveyor and then automatically transported. When the air cargo passes through a gate, electric power is supplied to the IC cards from an antenna provided near the gate. The IC cards are activated by the electric power, and data are read from or written into the IC cards by an electromagnetic induction system.

As a result, encryption and writing data into the memory of the IC cards, and decryption and reading the data from the memory should be completed while the air cargo is passing through the gate. Since encryption and decryption takes longer time, it is difficult to complete everything while the IC card is passing through the gate.

It is an object of the present invention to solve at least the problems in the conventional technology.

Exemplary embodiments of the present invention are explained in detail below with reference to the accompanying drawings.

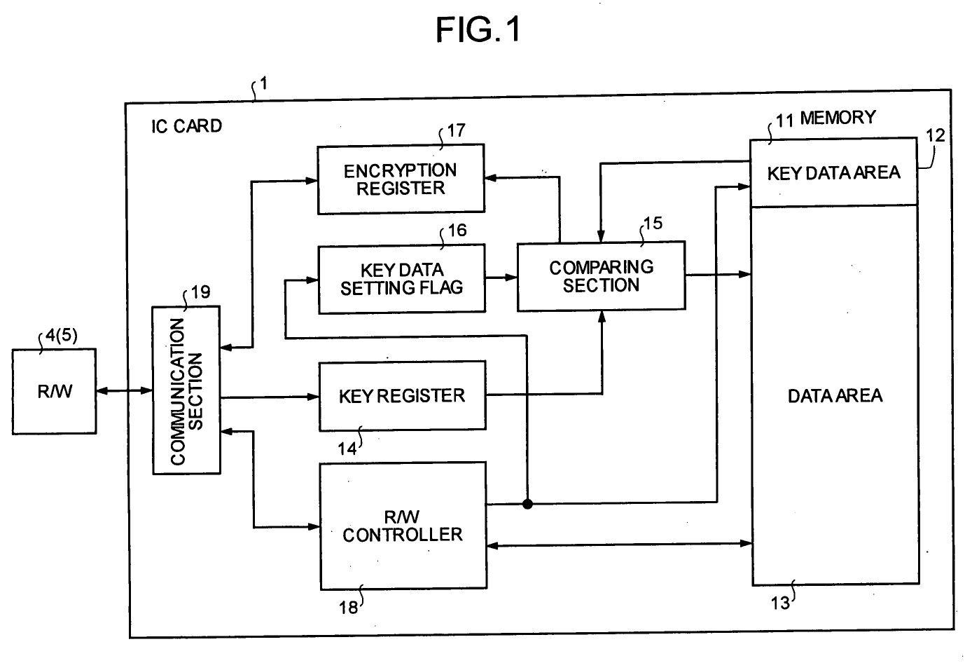

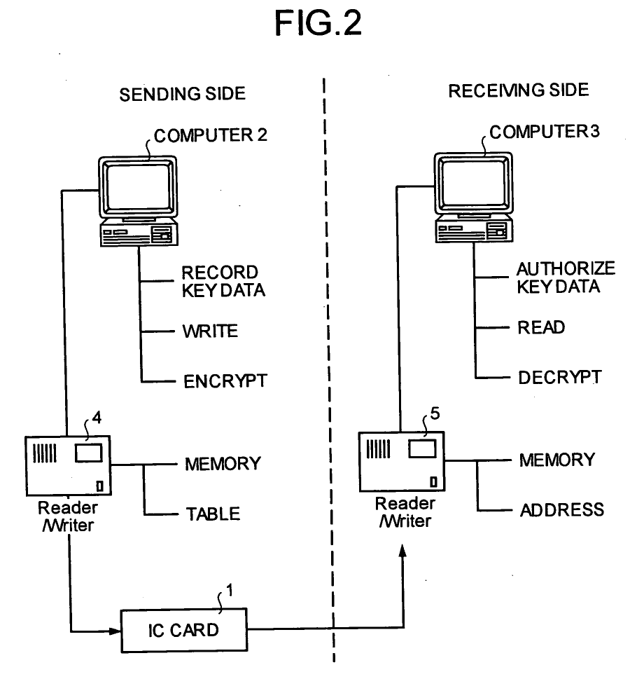

FIG. 1 is a block diagram of an IC card according to the first embodiment of the present invention. FIG. 2 is a schematic of an access limiting system according to the first embodiment.

In FIGS. 1 and 2, a computer 2 that includes a writing unit is a host of the sender of the IC card 1. A computer 3 that includes a reading/writing unit is a host of the receiver of the IC card 1. Readers/writers 4 and 5 are interface units used for transmission/reception of data when the data are read from or written into the IC card 1. The readers/writers 4 and 5 are connected to the host computers 2 and 3, respectively.

As shown in FIG. 2, the sender of the IC card 1 operates the computer 2 and accesses the IC card 1 via the reader/writer 4, for recording key data, writing data into a memory of the IC card 1, and encrypting the key data. On the other hand, the receiver of the IC card 1 operates the computer 3 and accesses the IC card 1 via the reader/writer 5, for authorizing the key data, reading the data from the memory of the IC card 1, and decrypting the encrypted key data.

As shown in FIG. 1, the IC card 1 has the memory 11, a key data area (second data area) 12, a data area (first data area) 13, a key register (third data area) 14, a comparing section 15, a key data setting flag (fifth data area) 16, an encryption register (fourth data area) 17, a read/write controller 18, and a communication section 19. The memory 11 is composed of a readable and rewritable nonvolatile memory such as a ferroelectric memory, a readable and rewritable read-only memory such as an electrically batch-erasable flash memory, or an electrically erasable memory such as an EEPROM (electrically erasable programmable ROM).

The memory 11 includes the key data area 12 where key data are stored, and the data area 13 into/from which data can be written or read by the sender or the receiver. The memory 11 includes 254 blocks, for example, (a number of blocks is not particularly limited to this), and one of the blocks is allocated as the key data area 12, and the rest of them as the data area 13. Data are read from or written into the memory 11 in blocks.

The key data are a password for setting authorization or inhibition of access to the data area 13. When the sender records key data, the key data are transmitted from the reader/writer 4 via the communication section 19 to the read/write controller 18. When the read/write controller 18 controls writing, the key data are written into the key data area 12. Only writing of data can be performed in the key data area 12. However, the written key data cannot be read from the key data area 12.

The key register 14 is an area for storing data, which are compared with the key data written into the key data area 12. The data, which are input by the sender or the receiver at the time of the key data authorizing process, are written into the key register 14 via the readers/writers 4 and 5 and the communication section 19. The data stored in the key register 14 cannot be read. Only writing of data can be performed in the key register 14.

The comparing section 15 compares the key data stored in the key data area 12 with the data stored in the key register 14. If they match, an enable signal is asserted for the memory 11 and the encryption register 17, and the access to the data area 13 and the encryption register 17 are authorized. If the data do not match, the enable signal is negated, so that the access to the data area 13 and the writing into the encryption register 17 are inhibited.

When the key data are written into the key data area 12, writing control of the read/write controller 18 sets the key data setting flag 16. When the key data setting flag 16 is set, the comparison of the two data in the comparing section 15, and the assertion or negation of the enable signal for the memory 11 based on the comparison result, are valid. As a result, the access to the data area 13 is authorized or inhibited as mentioned above. When the key data setting flag 16 is not set, namely, the key data are not written in the key data area 12, the enable signal output from the comparing section 15 is always asserted, so that the access to the data area 13 is authorized.

The encryption register 17 is an area for storing the encrypted key data therein. The sender encrypts the key data using the computer 2 (see FIG. 2). The encrypted key data are written via the reader/writer 4 and the communication section 19 into the encryption register 17. Not only the writing but also the reading of the encrypted key data is possible from the encryption register 17. The receiver reads the encrypted key data stored in the encryption register 17 via the reader/writer 5 and the communication section 19, and decrypts the encrypted key data using the computer 3 (see FIG. 2). As a result, the receiver can get key data stored in the key data area 12. Only when the key data in the key data area 12 match the data in the key register 14, the comparing section 15 makes the reader/writer 5 write the key data into the encryption register 17. Thus, when the data in the key data area 12 and the key register 14 are identical, both, reading and writing operations on the encryption register 17 are possible. However writing into the encryption register is possible only when the data in the key data area 12 and the key register 14 are identical.

The read/write controller 18 controls the writing and the reading of the data into/from the key data area 12 and the data area 13. The communication section 19 transmits and receives data between the readers/writers 4 and 5 using a contact system, namely, electrically, or using a non-contact system, namely, the electromagnetic induction system. Further, electric power for driving the IC card 1 is supplied to the communication section 19 from the readers/writers 4 and 5.

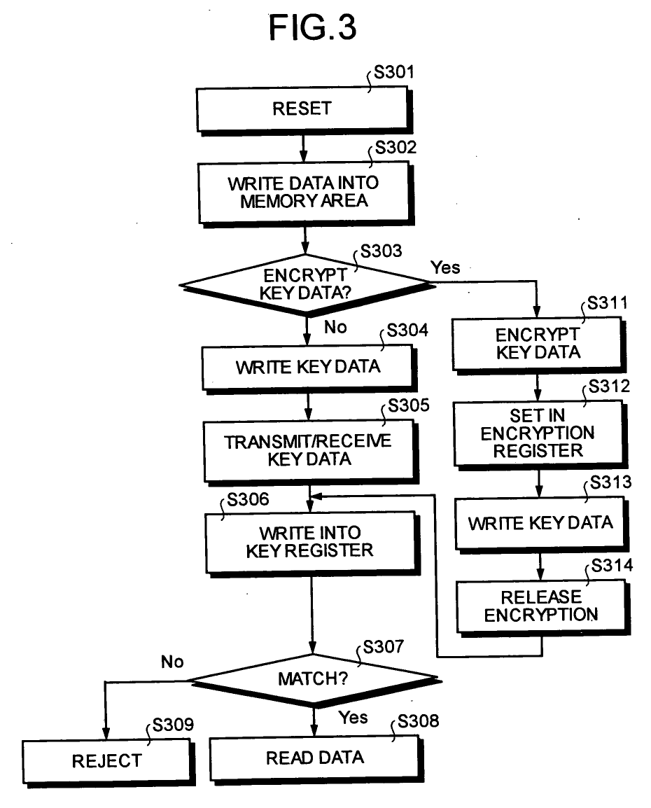

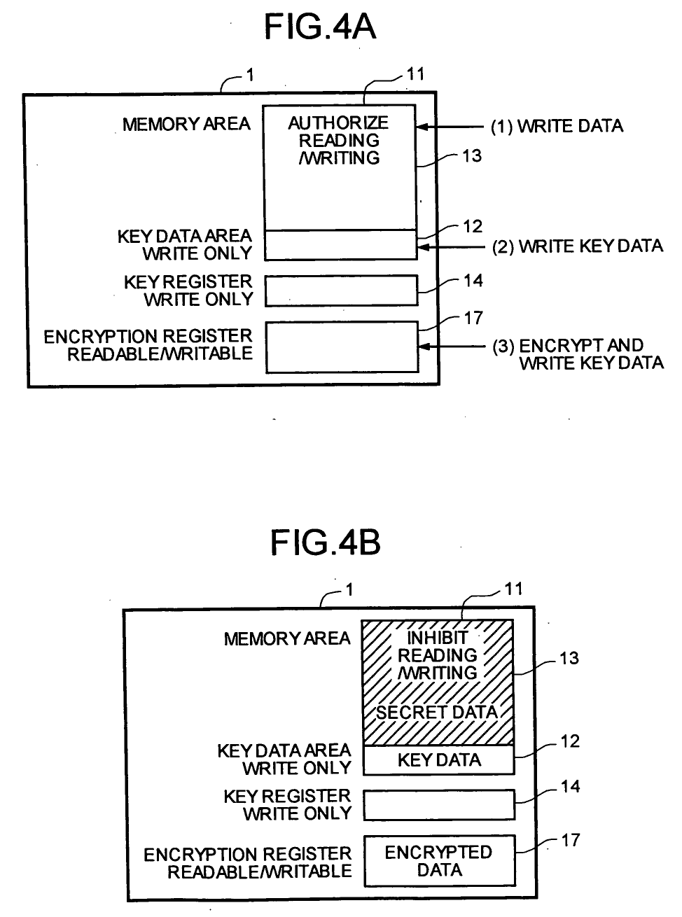

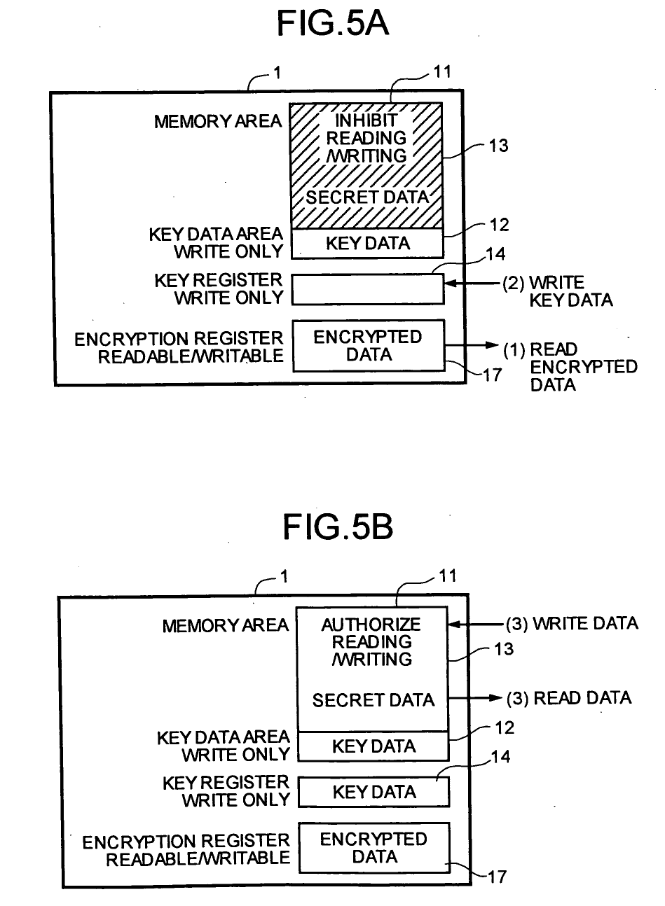

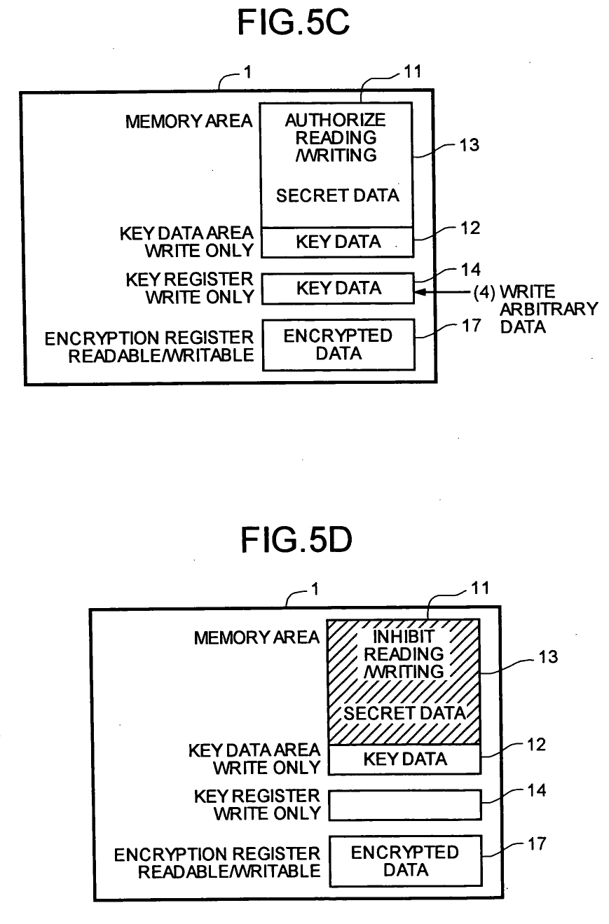

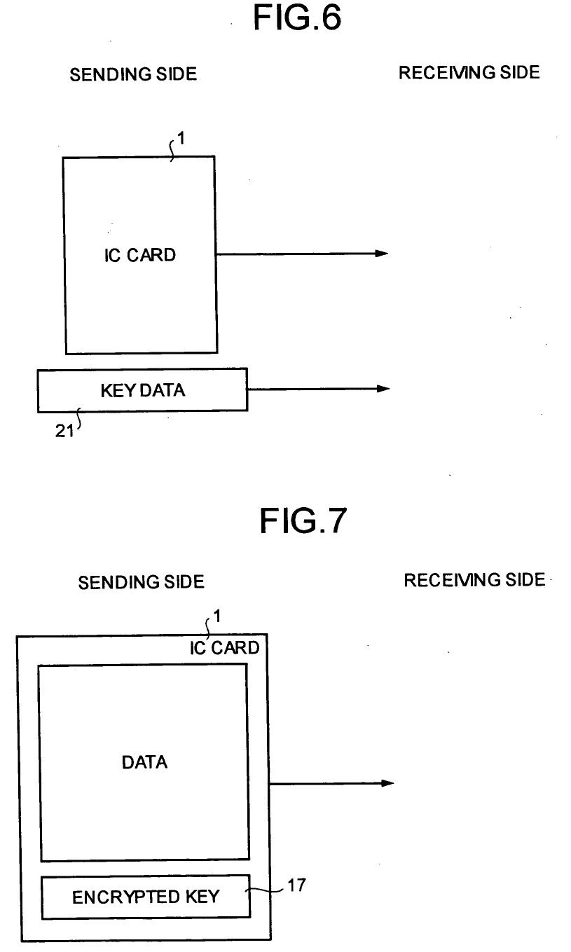

FIG. 3 is a flowchart of a method of accessing the IC card according to the first embodiment. FIGS. 4A to 5D are views to explain contents of a memory in the IC card when the access method is executed. FIGS. 6 and 7 are examples of transmission/reception of the key data and the IC card.

The sender resets the IC card 1 (step S301). As a result, all the memory areas, including the key data area 12, the data area 13, the key register 14, the key data setting flag 16, and the encryption register 17, are initialized. The IC card 1 is thus set to a usable state.

The sender writes desired data into the data area 13 (step S302). At this time, since the key data are not written into the key data area 12, the data area 13 is in a state that data can be written and read.

The sender has an option of storing the key data as they are or after being encrypted. The sender selects whether the key data are to be encrypted (step S303). If the key data are not to be encrypted .(No at step S303), the sender writes the key data as they are into the key data area 12 (step S304). At this time, the key data setting flag 16 is set. As a result, the data area 13 is set to a state that the reading and the writing of data are inhibited unless authorized by inputting the key data.

The sender sends both, the IC card 1 and the key data 21 to the receiver (step S305, see FIG. 6). The key data 21 to be sent to the receiver may optionally be encrypted by any known technique. In this case, the sender should inform the receiver of a password for decrypting the encrypted key data 21.

On the other hand, if the key data are to be encrypted (Yes at step S303), the sender encrypts the key data using a public key (step S311). The sender writes the encrypted key data into the encryption register 17 (step S312), and writes the key data into the key data area 12 (step S313). The sender sends the IC card 1 to the receiver. As a result, the sender can send the IC card 1, with the encrypted key data included therein, to the receiver (see FIG. 7).

FIGS. 4A and 4B illustrate change states of the key data area 12, the data area 13, and the registers 14 and 17 of the IC card 1 at the time of encrypting the key data. As against the case shown in FIGS. 4A and 4B, when the key data are not encrypted, the encrypted key data are not written into the encryption register 17; thus, the encryption register 17 will be empty.

At a state that the receiver receives the IC card 1, the data area 13 is in a state that the reading and the writing of data are inhibited (see FIG. 5A). If the encrypted key data are written into the encryption register 17, the receiver releases the encryption (decrypts the encrypted key data) using a secret key for the public key so as to acquire the key data (step S314 in FIG. 3). The receiver writes the decrypted key data into the key register 14 (step S306).

On the other hand, if the receiver receives the key data 21 and the IC card 1 separately, the receiver writes the key data 21 into the key register 14 (step S306). At this time, when the key data 21 are encrypted, the receiver decrypts the key data 21 using the password received from the sender. FIG. 5A illustrates the state of the key data area 12, the data area 13, and the registers 14 and 17 of the IC card 1 at this time.

When the receiver writes the key data into the key register 14, the IC card 1 determines whether the key data written into the key data area 12 match the key data in the key register 14 (step S307). If they match (Yes at step S307), the IC card 1 authorizes the receiver to access to the data area 13. As a result, the receiver can read the data from the data area 13 (step S308). Further, the receiver can write data into the data area 13. This state is illustrated in FIG. 5B. On the other hand, if the data do not mach (No at step S307), the IC card 1 inhibits the access to the data area 13, and therefore the receiver cannot read the data from the data area 13 (step S309).

In order to bring the data area 13 again into the access inhibiting state after the access to the data area 13 is authorized and the reading or the writing of the data from/into the data area 13 is completed, the receiver writes arbitrary data, which are different from the key data written into the key data area 12, into the key register 14. As a result, the reading and the writing of the data from/into the data area 13 are inhibited. This state is illustrated in FIGS. 5C and 5D.

According to the first embodiment, only when the data externally input as the key data match the key data stored in advance in the key data area 12, the access to the data area 13 of the memory 11 in the IC card 11 is authorized. For this reason, anyone other than the person who knows the proper key data is prevented from acquiring or interpolating secret data stored in the data area 13.

According to the first embodiment, since data that are not encrypted can be stored in the data area 13, the data encryption and decryption processes are not necessary, so that the processes of reading and writing data from/into the data area 13 can be executed at a high speed. Therefore, even if the IC card 1 is used instead of tags for air cargo, desired information can be written into and read from the IC card 1 within the short span of time that the IC card 1 is passing through a gate.

According to the first embodiment, data can be written into the key data area 12 of the memory 11 in the IC card 1, but data cannot be read therefrom. For this reason, leakage of the key data from the key data area 12 can be prevented.

The second embodiment is another example of the method of accessing the IC card. Since the constitution of the IC card and the constitution of the access limiting system for the IC card are the same as those in the first embodiment, the explanation thereof in the second embodiment uses the same reference numerals as those in the first embodiment.

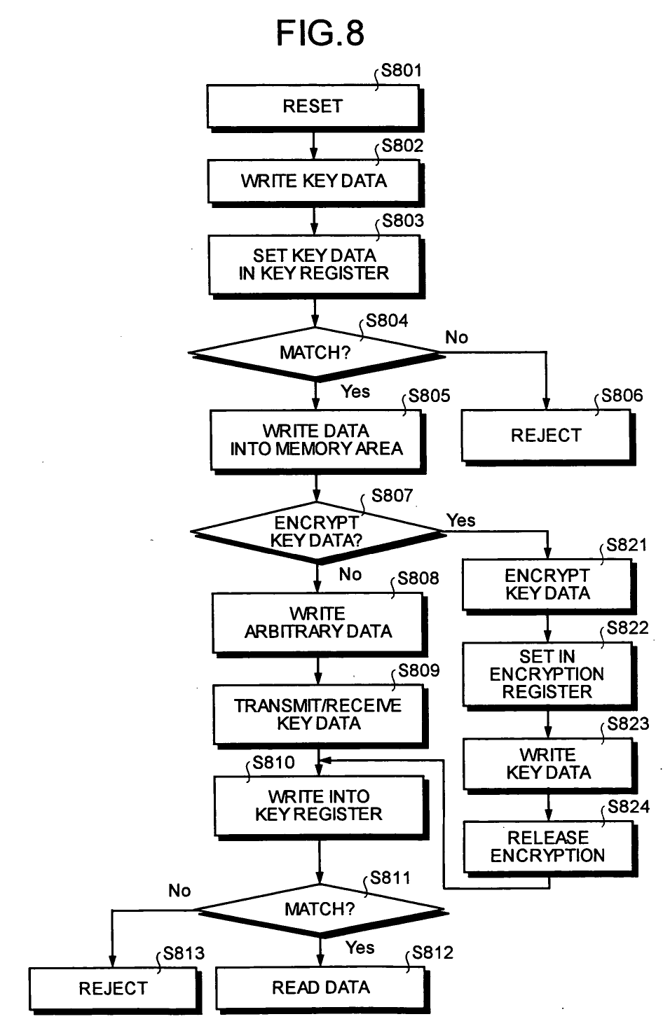

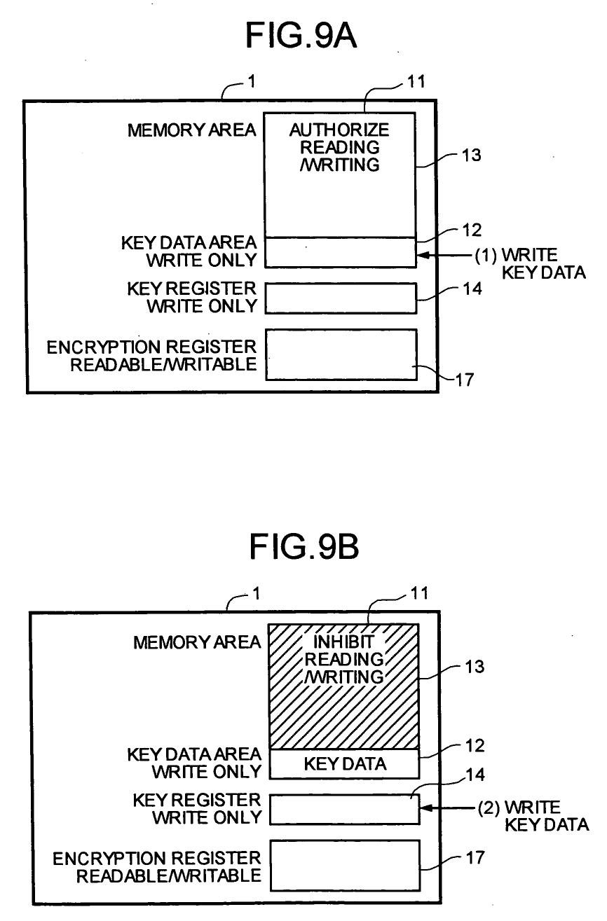

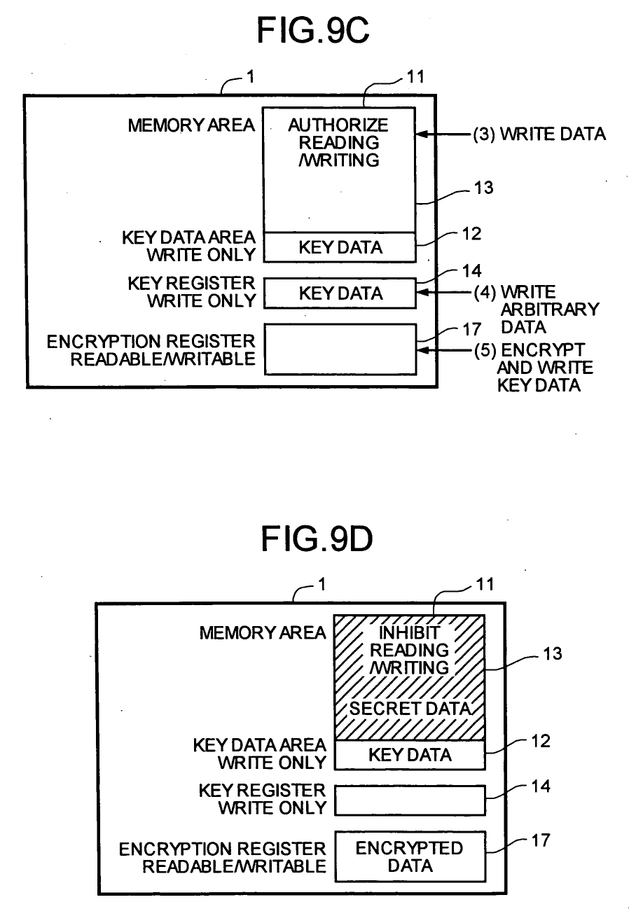

FIG. 8 is a flowchart of a method of accessing the IC card according to the second embodiment. FIGS. 9A to 9D are views to explain contents of a memory in the IC card when the access method is executed according to the second embodiment.

The sender resets the IC card 1, so that the IC card 1 is set to the usable state (step S801). At this time, all the memory areas, including the key data area 12, the data area 13, the key register 14, the key data setting flag 16, and the encryption register 17, are initialized.

The sender writes key data into the key data area 12 (step S802, see FIG. 9A). At this time, the key data setting flag 16 is set. Thereafter, the access to the data area 13 is inhibited. The sender inputs the key data into the key register 14 in order to write data into the data area 13 (step S803, see FIG. 9B).

The IC card 1 determines whether the key data written into the key data area 12 match the data in the key register 14 (step S804). If they match each other (Yes at step S804), the access to the data area 13 is authorized, and thus the sender writes desired data into the data area 13 (step S805, see FIG. 9C). However, if the data do not match each other (No at step S804), the IC card 1 rejects the access to the data area 13 (step S806).

After the data is written into the data area 13, presence of encryption is determined (step S807). If the encryption is not performed (No at step S807), the sender writes arbitrary data different from the key data into the key data area 12 in order to delete the key data set in the key data area 12 (step S808, see FIG. 9C). As a result, since the data set in the key register 14 do not match the key data written into the key data area 12, the access to the data area 13 is inhibited once again. The key data written into the key data area 12 becomes secret. No one other than a person who knows the key data, therefore, can access to the data area 13.

Steps after step S807 are the same as the steps S303 to S314 of the first embodiment (see FIG. 3). The steps S303, S304, S305, S306, S307, S308, S309, S310, S311, S312, S313, and S314 in the first embodiment are, therefore, considered as steps S807, S808, S809, S810, S811, S812, S813, S821, S822, S823, and S824, and thus the explanation of these steps is omitted here.

FIGS. 9C and 9D illustrate change states of the key data area 12, the data area 13, and the encryption register 17 when the key data are encrypted. As against the case shown in FIGS. 9C and 9D, when the key data are not encrypted, the encrypted data are not written into the encryption register 17; thus, the encryption register 17 will be empty.

According to the second embodiment, similar to the first embodiment, the secret data stored in the data area 13 can be prevented from leaking and being interpolated, the reading and the writing of the data from/into the data area 13 are performed at a higher speed, and the key data can be prevented from leaking from the IC card 1.

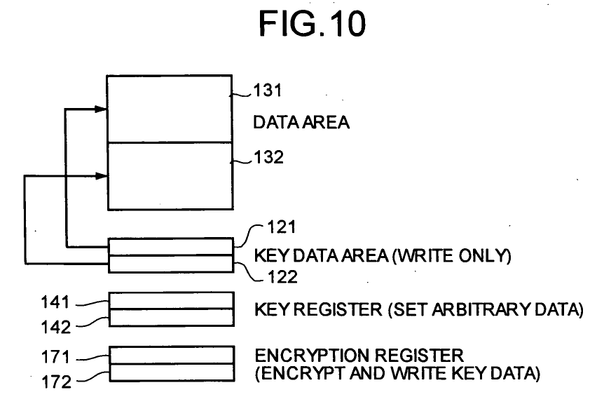

The third embodiment is one example of the access method when the data area 13 is divided into a plurality of sub data areas. The IC card in the third embodiment has the same constitution as that in the first embodiment, and the access in each sub data area is limited. As shown in FIG. 10, the data area 13 is divided into two sub data areas 131 and 132. Number of sub data areas is not, however, particularly limited to two.

The IC card is provided with a first key data area 121 corresponding to sub data area 131, and a second key data area 122 corresponding to sub data area 132. Further, two key registers 141 and 142, two key data setting flags (not shown), and two encryption registers 171 and 172 are provided. The other parts of the constitution of the IC card, and the constitution of the access limiting system for the IC card are the same as those in the first embodiment. Therefore, these portions in the third embodiment are explained using the same reference numerals as those in the first embodiment.

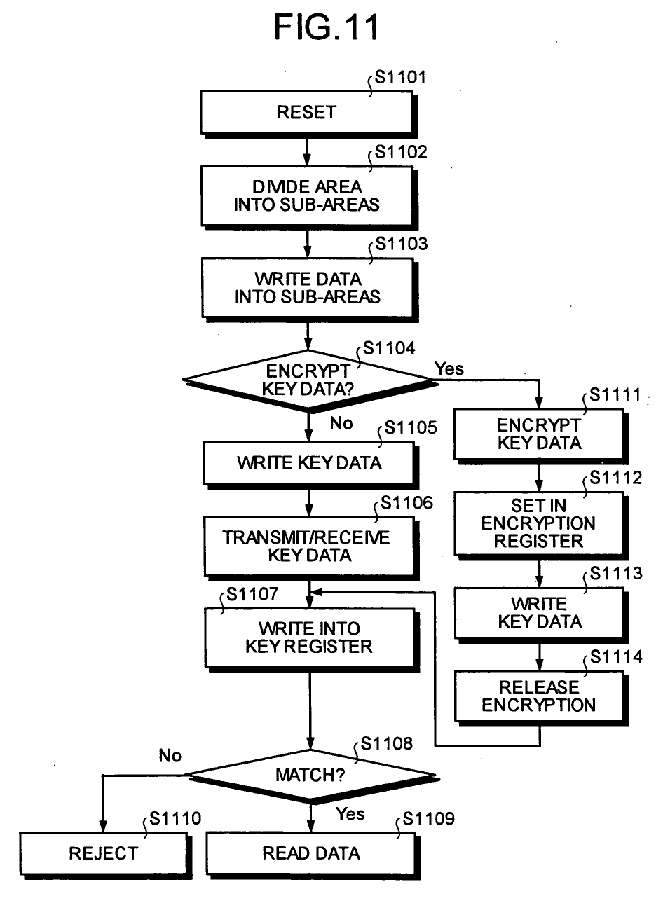

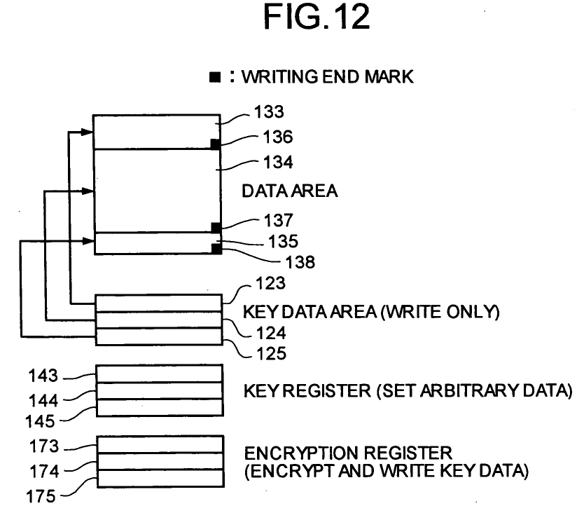

FIG. 11 is a flowchart of a method of accessing the IC card according to the third embodiment.

The sender resets the IC card 1 so that all the memory areas including the key data areas 121 and 122, the sub data areas 131 and 132, the key registers 141 and 142, the key data setting flags 16, and the encryption registers 171 and 172 are initialized. The IC card 1 is thus set to a usable state (step S1101).

The sender divides the data area 13 into the sub data area 131 and the sub data area 132 (step S1102). In this case, a table, which represents correspondence between each sub data area and its corresponding head address, is created in a predetermined area of the memory 11.

The sender writes desired data into one of or both of the sub data area 131 and the sub data area 132 (step S1103). The sender has an option of storing the key data as they are or after being encrypted. The sender selects whether the key data are to be encrypted (step S1104). If the key data are not to be encrypted (No at step S1104), the sender writes the key data as they are, into the key data areas 121 and 122 (step S1105). At this time, in order to limit the access to the sub data area 131 (or the sub data area 132) and enable free access to the sub data area 132 (or the sub data area 131), the key data may be written into only the key data area 121 corresponding to the sub data area 131 (or the key data area 122 corresponding to the sub data area 132).

In order to limit the access to both the sub data area 131 and the sub data area 132, the key data may be written into both the key data areas 121 and 122. The key data in both the key data areas 121 and 122 may be identical or different from each other. If the key data are different, the access to the sub data area 131 and the access to the sub data area 132 can be limited independently.

When the key data are written, the key data setting flags 16 are set, so that the access to the sub data areas 131 and 132 corresponding to which the key data are set, is inhibited. Thereafter, the sender sends both, the IC card 1 and the key data, to the receiver, and informs the receiver of the key data and the sub data area corresponding to the key data (step S1106).

On the other hand, if the key data are to be encrypted (Yes at step S1104), the sender encrypts the key data (step S1111), writes the encrypted key data into the encryption registers 171 and 172 (step S1112), and writes the key data into the key data areas 121 and 122 (step S1113). The encrypted key data corresponding to the sub data area 131 are written into the encryption register 171. Similarly, the encrypted key data corresponding to the sub data area 132 are written into the encryption register 172. The sender sends the IC card 1, with the encrypted key data included therein, to the receiver.

Upon receiving the IC card 1, if encrypted key data are written into the encryption registers 171 and 172, the receiver releases the encryption (decrypts the encrypted key data) so as to acquire the key data (step S1114). The decrypted key data are written into the key registers 141 and 142 (step S1107). However, if the receiver receives the key data and the IC card 1 separately, the receiver writes the corresponding key data directly into the key registers 141 and 142 (step S1107).

The comparing section compares the key data in the key registers 141 and 142 with the key data in the key data areas 121 and 122, respectively (step S1108). If the key data match (Yes at step S1108), the access to the sub data areas corresponding to the matched key data is authorized. As a result, the receiver can read the data from a sub data area if the access is authorized (step S1109). On the other hand, if the key data do not match (No at step S1108), the access to the sub data areas corresponding to the unmatched key data is inhibited. As a result, the access by the receiver is rejected (step S1110).

According to the third embodiment, the access to the plural sub data areas 131 and 132 can be limited independently. Similar to the first embodiment, the secret data stored in the data area 13 can be prevented from leaking and being interpolated, the reading and the writing of data from/into the data area 13 can be performed at a higher speed, and the key data can be prevented from leaking from the IC card 1.

The fourth embodiment is another example of the access method when the data area 13 is divided into a plurality of sub data areas. The IC card in the fourth embodiment has the same constitution as that in the first embodiment, and the access in each sub data area is limited, as in the third embodiment. The fourth embodiment is different from the third embodiment in that size of the individual sub data areas can be set according to length of data to be written into the data area 13.

In the third embodiment, the size of each sub data area is fixed. On the contrary, in the fourth embodiment, the size of the individual sub data areas is variable. Further, number of sub data areas provided in the data area 13 is variable, and can be increased until a free storage capacity of the data area 13 becomes zero or insufficient.

As shown in FIG. 12, it is assumed that the data area 13 is divided into three sub data areas 133, 134, and 135. Number of sub data areas is not limited to three.

The IC card is provided with a first key data area 123 corresponding to the sub data area 133, a second key data area 124 corresponding to the sub data area 134, and a third key data area 125 corresponding to the sub data area 135. Three key registers 143, 144 and 145, three key data setting flags (not shown) and three encryption registers 173, 174 and 175 are provided.

The number of the key data areas 123, 124 and 125, the key registers 143, 144 and 145, the key data setting flags, and the encryption registers 173, 174 and 175 is not limited to three. The number can be equal to a maximum number of sub data areas that can be provided in the data area 13. The other portions of the constitution of the IC card and the constitution of the access limiting system for the IC card are the same as those in the first embodiment. Therefore, the fourth embodiment is explained by using the same reference numerals as those in the first embodiment.

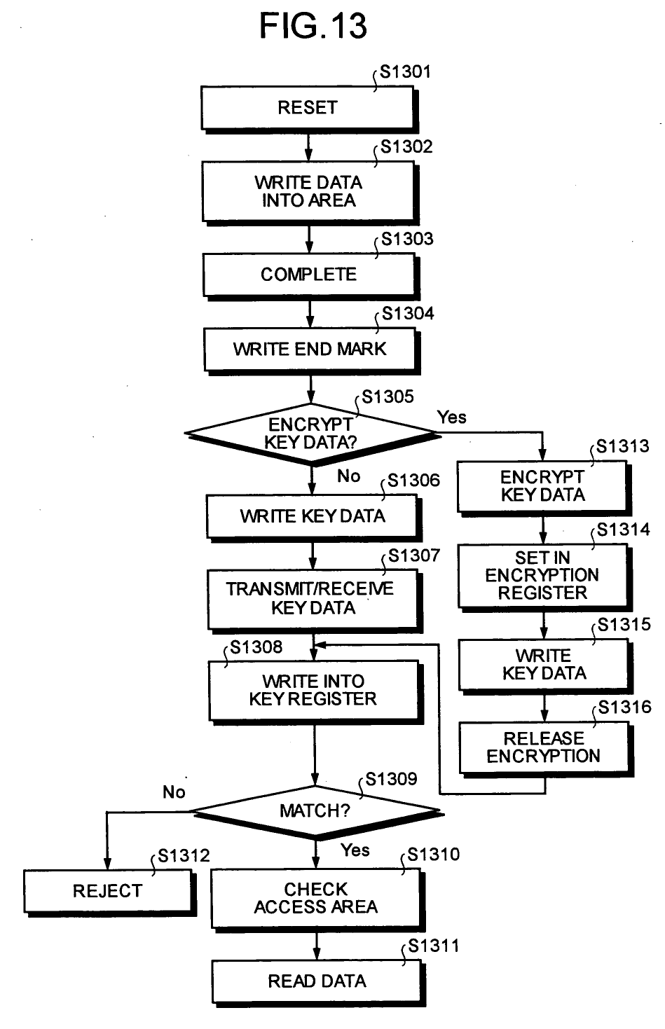

FIG. 13 is a flowchart of a method of accessing to the IC card according to the fourth embodiment.

The sender resets the IC card 1 so that all the memory areas, including the key data areas 123, 124 and 125, the sub data areas 133, 134 and 135, the key registers 143, 144 and 145, the key data setting flags 16, and the encryption registers 173,174 and 175, are initialized. Thus, the IC card 1 is set to a usable state (step S1301).

The sender writes desired data into the data area 13 (step S1302). When the writing of data is completed (step S1303), an end mark, that clarifies how much area (block) in the data area 13 is used for storing the data, is written (step S1304).

With reference to FIG. 12, sub data area 133 ranges from head of the data area 13 to a first end-mark 136. Sub data area 134 ranges from a block following the first end-mark 136 to a second end-mark 137. Sub data area 135 ranges from a block following the second end-mark 137 to a third end-mark 138.

The sender has an option of storing the key data as they are or after being encrypted. The sender selects whether the key data are to be encrypted (step S1305). If the key data are not to be encrypted (No at step S1305), the sender writes the key data as they are, into the key data areas 123, 124 and 125 (step S1306). As mentioned earlier, number of the accessible areas is not limited to three. Similar to the third embodiment, the access to any one or two of the sub data areas 133, 134, and 135 can be limited, so that the access to the rest of the areas can be performed freely. In this case, similarlto the third embodiment, the key data may be written into only those key data areas that correspond to the sub data areas where access is to be limited.

When the key data are written, the key data setting flags 16 are set, so that the access to those sub data areas corresponding to which the key data are set, is inhibited. The sender sends both, the IC card 1 and the key data, to the receiver, and informs the receiver of the key data and the sub data areas corresponding to the key data (step S1307).

On the other hand, if the key data are to be encrypted (Yes at step S1305), the sender encrypts the key data (step S1313), writes the encrypted key data corresponding to the sub data areas 133, 134 and 135 into the encryption registers 173, 174 and 175 (step S1314), and writes the key data into the key data areas 123, 124 and 125 (step S1315). The sender sends the IC card 1, with the encrypted key data included therein, to the receiver.

Upon receiving the IC card 1, if the encrypted key data are written into the encryption registers 173, 174 and 175, the receiver releases the encryption (decrypts the encrypted key data) so as to acquire the key data (step S1316). The corresponding decrypted key data are written into the key registers 143, 144 and 145 (step S1308). However, if the receiver receives the key data and the IC card 1 separately, the receiver writes the corresponding key data directly into the key registers 143, 144 and 145 (step S1308).

The comparing section compares the key data in the key registers 143, 144, and 145 with the key data in the key data areas 123, 124, and 125, respectively (step S1309). If the key data match (Yes at step S1309), the access to the sub data areas corresponding to the matched key data is authorized. The IC card 1 finds the exact location of the sub data area authorized. Concretely, the IC card 1 finds the end mark of the sub data area to be accessed and one previous end mark, and authorizes access to the data area between these end marks (step S1310).

As an example, the case where the access to sub data area 134 is authorized and the receiver accesses the sub data area 134 is explained with reference to FIG. 12. The IC card 1 finds the second end mark 137 of the sub data area 134 and the previous end mark, that is, the first end mark 136 of the sub data area 133. The IC card 1 accesses an area from a block following the first end mark 136 to a block including the second end mark 137 as sub data area 134.

After the IC card 1 locates the sub data area that is authorized, the receiver can access that sub data area and read data therein (step S1311). On the contrary, if the key data do not match (No at step S1309), the access to the sub data areas 133, 134 and 135 corresponding to the unmatched key data is inhibited. Thus, access by the receiver is rejected (step S1312).

In the above case, the end marks 136, 137 and 138 are written at the end of the sub data areas 133, 134 and 135, respectively, and the IC card 1 accesses the sub data areas 133, 134 and 135 using the end marks 136, 137 and 138 as a guide. Instead of this, a table representing correspondence between the sub data areas 133, 134 and 135 and their head addresses may be created in a predetermined area of the memory 11, for example, so that the IC card 1 can access the sub data areas 133, 134 and 135 using the table.

According to the fourth embodiment, the access to the plural sub data areas 133, 134 and 135 can be limited independently. Further, similar to the first embodiment, the secret data stored in the data area 13 can be prevented from leaking and being interpolated, can be read and the written at a higher speed, and the key data are prevented from leaking from the IC card 1.

The present invention is not limited to the above embodiments and can be modified as desired. The memory device according to the present invention is not limited to the IC card as a tag, and it can be applied also to a credit card, an IC card for identification, and an IC card such as an employee ID card. The system according to the present invention is not limited to transportation services of air cargo, and can be applied also to assembly services such as door-to-door delivery, stock management in storehouses.

According to the present invention, the key data cannot be read, and when appropriate key data is input, the access to secret data stored in the memory device is authorized. If incorrect key data is input, the access to the secret data stored in the memory device is inhibited. Therefore, data can be stored in the memory device without encrypting, and the stored data can be prevented from leaking and being interpolated.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A memory device comprising:
a nonvolatile first data area that stores first data that are not encrypted and that can be read and written;
a nonvolatile first key data area that stores first key data that can be written but can not be read;
a nonvolatile second key data area that stores second key data that can be written but can not be read; and
a controller that allows reading or writing of the first data when the first key data matches with the second key data.

2. The memory device according to claim 1, further comprising a comparing unit that compares the first key data with the second key data, wherein
the controller allows the reading or the writing of the first data based on the result of comparison performed by the comparing unit.

3. The memory device according to claim 2, if the first key data match second key data, the comparing unit authorizes the reading or the writing of the first data, and if the first key data do not match the second key data, the comparing unit inhibits the reading and the writing of the first data.

4. The memory device according to claim 1, further comprising a nonvolatile second data area that stores second data that can be read and written, and that are obtained by encrypting the first key data.

5. The memory device according to claim 4, further comprising a comparing unit that compares the first key data with the second key data, wherein
the controller allows the reading or the writing of the second data based on the result of comparison performed by the comparing unit.

6. The memory device according to claim 5, wherein if the first key data match the second key data, the comparing unit authorizes the reading or the writing of the second data, and if the first key data do not match the second key data, the comparing unit authorizes only the reading but inhibits the writing of the second data.

7. The memory device according to claim 1, further comprising a third data area that stores third data that are set when the first key data are stored, and are cleared when the first key data is reset.

8. The memory device according to claim 1, further comprising a communication unit that receives the first data, the first key data, and the second key data from outside, and output the first data to the outside.

9. The memory device according to claim 1, wherein the memory device is driven by an external electric power supply.

10. The memory device according to claim 1, wherein the first data area is divided into a plurality of sub data areas each containing the first data, the first key data area is divided into a plurality of sub key data areas each containing the first key data, the second key data area is divided into a plurality of sub key registers each containing the second key data, and if the first key data stored in a desired one of the sub first key data areas matches with the second key data stored in a corresponding one of the sub second key data areas, the controller allows the reading or the writing of the first data in a corresponding of the sub data area.

11. The memory device according to claim 10, wherein all the sub data areas have same memory capacity.

12. The memory device according to claim 10, wherein each of the sub data area has a different memory capacity.

13. The memory device according to claim 10, wherein a memory capacity of each of the sub data area is set based on a length of data to be stored in the sub data area.

14. The memory device according to claim 1, wherein the first data area and the first key data area are composed of a ferroelectric memory that holds the data by means of remnant polarization.

15. A memory access limiting system, comprising:
a memory device that includes
a nonvolatile first data area that stores first data that are not encrypted and that can be read and written;
a nonvolatile first key data area that stores first key data that can be written but can not be read;
a nonvolatile second key data area that stores second key data that can be written but can not be read; and
a controller that allows reading or writing of the first data when the first key data matches with the second key data;
a writing unit that writes the first data into the first data area and the first key data into the first key data area;
a first interface unit that is used for transmission and reception of data between the writing unit and the memory device;
a reading/writing unit that writes the second key data into the second key data area, and accesses the first data area for reading and writing the first data; and
a second interface unit that is used for transmission and reception of data between the reading/writing unit and the memory device.

16. The memory access limiting system according to claim 15, further comprising a comparing unit that compares the first key data with the second key data, wherein
the controller allows the reading or the writing of the first data based on the result of comparison performed by the comparing unit.

17. The memory access limiting system according to claim 16, if the first key data match second key data, the comparing unit authorizes the reading or the writing of the first data, and if the first key data do not match the second key data, the comparing unit inhibits the reading and the writing of the first data.

18. The memory access limiting system according to claim 15, further comprising a nonvolatile second data area that stores second data that can be read and written, and that are obtained by encrypting the first key data.

19. The memory access limiting system according to claim 18, further comprising a comparing unit that compares the first key data with the second key data, wherein
the controller allows the reading or the writing of the second data based on the result of comparison performed by the comparing unit.

20. The memory access limiting system according to claim 19, wherein if the first key data match the second key data, the comparing unit authorizes the reading or the writing of the second data, and if the first key data do not match the second key data, the comparing unit authorizes only the reading but inhibits the writing of the second data.

21. The memory access limiting system according to claim 15, further comprising a third data area that stores third data that are set when the first key data are stored, and are cleared when the first key data is reset.

22. The memory access limiting system according to claim 15, wherein the memory device further includes a communication unit that receives the first data, the first key data, and the second key data from the writing unit via the first interface unit, and outputs the first data to the reading/writing unit via the second interface unit.

23. The memory access limiting system according to claim 15, wherein the memory device is driven by an external electric power supply.

24. The memory access limiting system according to claim 15, wherein the first data area is divided into a plurality of sub data areas each containing the first data, the first key data area is divided into a plurality of sub key data areas each containing the first key data, the second key data area is divided into a plurality of sub key registers each containing the second key data, and if the first key data stored in a desired one of the sub first key data areas matches with the second key data stored in a corresponding one of the sub second key data areas, the controller allows the reading or the writing of the first data in a corresponding of the sub data area.

25. The memory access limiting system according to claim 24, wherein all the sub data areas have same memory capacity.

26. The memory access limiting system according to claim 24, wherein each of the sub data area has a different memory capacity.

27. The memory access limiting system according to claim 24, wherein a memory capacity of each of the sub data area is set based on a length of data to be stored in the sub data area.

28. The memory access limiting system according to claim 15, wherein the first data area and the first key data area are composed of a ferroelectric memory that holds the data by means of remnant polarization.

29. A memory access method, comprising:
a first writing that includes writing a predetermined unencrypted data into a nonvolatile first data area from which data can be read and written after resetting the first data area, and writing key data into a nonvolatile second data area into which data can be written but can not be read;
inhibiting the reading and the writing of the first data;
a second writing that includes writing temporary key data into a nonvolatile key register, into which data can be written but can not be read when the reading and the writing of the first data are inhibited; and
authorizing the reading or writing of the first data when the temporary key data match the key data, whereas inhibiting the reading and the writing of the first data when the temporary key data do not match the key data.

30. The memory access method according to claim 29, before the second writing, further comprising:
encrypting and writing the key data as encrypted data, into a nonvolatile second data area that stores second data that can be read and written; and
reading and decrypting the encrypted data so as to acquire the key data,
wherein the key data acquired by decrypting the encrypted data are written as the temporary key data into the key register at the second writing.
